(19) United States
(12) Patent Application Publication
(10) Pub. No.: US 2024/0371283 A1
(43) Pub. Date: Nov. 7, 2024

(54) METHOD OF MUSIC INSTRUCTION

(71) Applicant: Music Academy Success, LLC, Irmo, SC (US)

(72) Inventor: Thomas M. Fort, Irmo, SC (US)

(73) Assignee: Music Academy Success, LLC, Irmo, SC (US)

(21) Appl. No.: 18/777,262

(22) Filed: Jul. 18, 2024

Related U.S. Application Data
(63) Continuation-in-part of application No. 17/550,587, filed on Dec. 14, 2021.
Application No. 17/550,587 is a continuation of application No. 17/147,669, filed on Jan. 13, 2021, now Pat. No. 11,227,503.
Application No. 17/147,669 is a continuation of application No. 15/059,593, filed on Mar. 3, 2016, now abandoned.
(60) Provisional application No. 62/129,430, filed on Mar. 6, 2015.

(51) Int. Cl. G09B 5/00

(52) U.S. Cl. CPC G09B 5/00

(57) ABSTRACT

A computerized system and method of music instruction can comprise a system in which students receive a different colored wristband upon completing various intervals of training. Each wristband can provide a sense of accomplishment to the student and provide an incentive for the student to continue his/her training. Students can receive the first wristband upon completing three months of lessons, and a different wristband after completing each three-month interval thereafter until reaching eighteen months. After eighteen months, a different wristband can be awarded at each six-month interval until completing thirty-six months of lessons. Students can also receive certificates and trophies in tandem with the wristbands upon completing certain intervals of training.

### CROSS REFERENCE TO RELATED APPLICATIONS

This is a continuation in part application that claims priority to U.S. patent application Ser. No. 17/550,587, filed on Dec. 14, 2021, which in turn claims priority to 17/147,669 filed Jan. 13, 2021 which in turn claims priority on U.S. patent application Ser. No. 15/059,593 filed Mar. 3, 2016 which in turn claims priority on U.S. Provisional Patent Application No. 62/129,430, filed Mar. 6, 2015, both of which are incorporated by reference.

### TECHNICAL FIELD OF INVENTION

The present invention relates to a computerized method and system of music instruction. In an embodiment of the invention, the software identifies awards to be provided to students based upon comparisons of the student progress data and various predetermined time thresholds and corresponding progress level tests. If a determination is made that the student progress data exceeds a predetermined time threshold and indicates that the students has passed the corresponding progress level test, the software identifies one of a plurality of awards levels, each of which may consist of physical decorations, such as various distinctively colored and/or labeled wristbands, to signify the student's completion of various levels of musical training.

### BACKGROUND OF INVENTION

Of the many children who begin lessons on a musical instrument, it is believed that the majority will quit within the second month of beginning lessons. Attrition in the music teaching industry is generally very high. Retaining students is typically vital to the success of a music school. The need to retain music students once obtaining them is a serious economic issue for commercial music schools and independent teachers. Keeping students interested and motivated is typically the most important factor in determining the success or failure of a music school.

### SUMMARY OF INVENTION

Therefore, one object of the present invention is to provide a computerized method of teaching music that minimizes student attrition by providing incentives to students to continue their lessons. These and other objects of the invention can be achieved in various embodiments of the invention described herein.

An embodiment of the invention comprises a “MUSICAL LADDER SYSTEM”, in which students receive a different colored wristband upon completing various intervals of training. Each wristband can provide a sense of accomplishment to the student and provide an incentive for the student to continue his/her training. Students can receive the first wristband upon completing three months of lessons, and a different wristband after completing each three-month interval thereafter until reaching eighteen months. After eighteen months, a different wristband can be awarded at each six-month interval until reaching a “master” status at thirty-six months. Students can also receive certificates and trophies in tandem with the wristbands upon completing certain intervals of training. The trophies can be up to three feet in height and inspire the students to stay with the music school.

According to another embodiment of the invention, the MUSICAL LADDER SYSTEM can include a parent portal software in which parents of students can log in and view their child's progress for the next award coming up, teacher notes, important dates, and their child's ‘status’ on the MUSICAL LADDER.

Another embodiment of the invention comprises a method of instruction comprising the steps of providing an initial lesson to a student, scheduling a first achievement milestone on a date sixty to one hundred days after the initial lesson, and providing an award to the student upon reaching the first achievement milestone.

According to another embodiment of the invention, the first achievement milestone and/or progress level test can be completion of a predetermined number of lessons by the student.

According to another embodiment of the invention, the first achievement milestone and/or progress level test can be a test that must be taken and passed by the student.

According to another embodiment of the invention, the first achievement milestone and/or progress level test is scheduled for ninety days after the initial lesson.

According to another embodiment of the invention, a second achievement milestone and/or progress level test can be scheduled on a date ninety days after the first achievement milestone and/or progress level test.

According to another embodiment of the invention, the award can be a wristband.

According to another embodiment of the invention, the wristband includes distinctive indicia thereon.

According to another embodiment of the invention, the distinctive indicia can include alphanumeric characters.

According to another embodiment of the invention, the distinctive indicia can include a decorative logo.

According to another embodiment of the invention, a computerized method of music instruction comprises providing an initial music lesson to a student, scheduling a first achievement milestone and/or progress level test about three months after the initial music lesson, and providing an award to the student upon reaching the first achievement milestone and/or progress level test.

According to another embodiment of the invention, a student can reach the first achievement milestone and/or pass the and/or the first progress level test by completing a predetermined number of lessons and/or passing a predetermined test.

According to another embodiment of the invention, a second achievement milestone and/or progress level test can be scheduled for three months after the first achievement milestone and/or progress level test, and a third achievement milestone and/or progress level test can be scheduled for three months after the second achievement milestone and/or progress level test.

According to another embodiment of the invention, a first plurality of additional achievement milestones and/or progress level tests can be scheduled beginning three months after the first achievement milestone and/or progress level test and continue every three months until eighteen months after the initial music lesson.

According to another embodiment of the invention, a second plurality of additional achievement milestones and/or progress level tests can be scheduled beginning two years after the initial music lesson and continue every six months until five years after the initial music lesson.

According to another embodiment of the invention, a third plurality of additional achievement milestones and/or progress level tests can be scheduled beginning six years after the initial music lesson and continuing every year until ten years after the initial music lesson.

Another embodiment of the invention comprises a non-transitory computer readable storage medium having programming instructions that, when executed, causes a computer processor to perform a method of operating a music school. The method can include maintaining student retention data comprised of how long each of the plurality of music students has taken lessons from the music school and maintaining instrument data comprised of which instrument each of the plurality of music students has taken lessons on from the music school. The student retention data is cross-referenced with the instrument data to produce an instrument retention report showing an average duration of lessons for each instrument.

According to another embodiment of the invention, the method includes maintaining student progress data for each of the plurality of music students. The student progress data can be progress toward an award, teacher comments, and deadlines. A parent portal can be provided by which parents of the plurality of music students can log in via the global computer network (e.g., Internet) and view the student progress data for their child.

According to another embodiment of the invention, student source data can be received and maintained for each of the plurality of music students. The student source data is a source by which each of the plurality of music students has been introduced to the music school, such as personal referral, walk in, Internet website, social media, radio advertising, television advertising, and print advertising. The student source data and the student retention data are cross-referenced to produce a student source report showing an average duration of lessons for each source.

According to another embodiment of the invention teacher data for each of the plurality of music students is maintained. The teacher data is the name of the teacher for each of the plurality of music students. The teacher data and the student retention data are cross-referenced to a teacher retention report showing an average duration of lessons for each teacher.

Another embodiment of the invention comprises a computerized method for motivation and retention of a musical student comprising a computer having a computer readable medium; a student database in communication with the computer; and, a set of computer readable instructions included on the computer configured to: receive a student progress data record representing a current progress level of musical training of the musical student; receive an instrument retention data representing an amount of time that the musical student takes music lessons with an instrument; identify a predetermined time threshold associated with the student progress data, wherein the predetermined time threshold is selected from the student's total lesson time the length of time that the student has been taking lessons and the length of time that the student has been taking lessons with an instrument; display a notification representing whether the instrument retention data exceeds the predetermined time threshold associated with the student progress data; display an identification of an award level corresponding to the notification; and, transmit using a global computer network a progress data to a parent portal, wherein the progress data represents one of a set of teacher notes, a child's progress towards a next award level in the set of award levels and a comparison of the award level achieved by the student to the next award level not yet achieved by the student. In such an embodiment the predetermined time thresholds and the level awards used, determined, identified and/or displayed b the software can be those that are disclosed in association with the Music Ladder System disclosed herein.

In another embodiment, the invention may comprise a a server having a server computer readable medium; a student database in communication with the server; and, a set of server computer readable instructions include on the server configured to: receive a student progress data record representing a current progress level of musical training of the musical student; determine a progress level test according to the student progress data record; determine a time threshold associated with the progress level test, wherein the time threshold represents a minimum required amount of time that the student has been taking musical training; compare the student progress data to the time threshold to determine whether the predetermined time threshold has been met; upon determining that the predetermined time threshold has been met, determine whether the student has passed the progress level test; and, identify an award to be presented to the student according to a determination that the time threshold has been met and a determination that the progress level test has been passed.

### BRIEF DESCRIPTION OF THE DRAWINGS

FIG. 1 is a schematic view illustrating a method of music instruction according to a preferred embodiment of the invention;

FIG. 2 is a schematic view illustrating a method of music instruction according to another preferred embodiment of the invention;

FIG. 3 is a schematic view illustrating a method of music instruction according to another preferred embodiment of the invention;

FIG. 4 is a perspective view of a wristband according to a preferred embodiment of the invention; and

FIG. 5 is a graph according to an embodiment of the invention.

### DETAILED DESCRIPTION OF PREFERRED EMBODIMENTS OF INVENTION

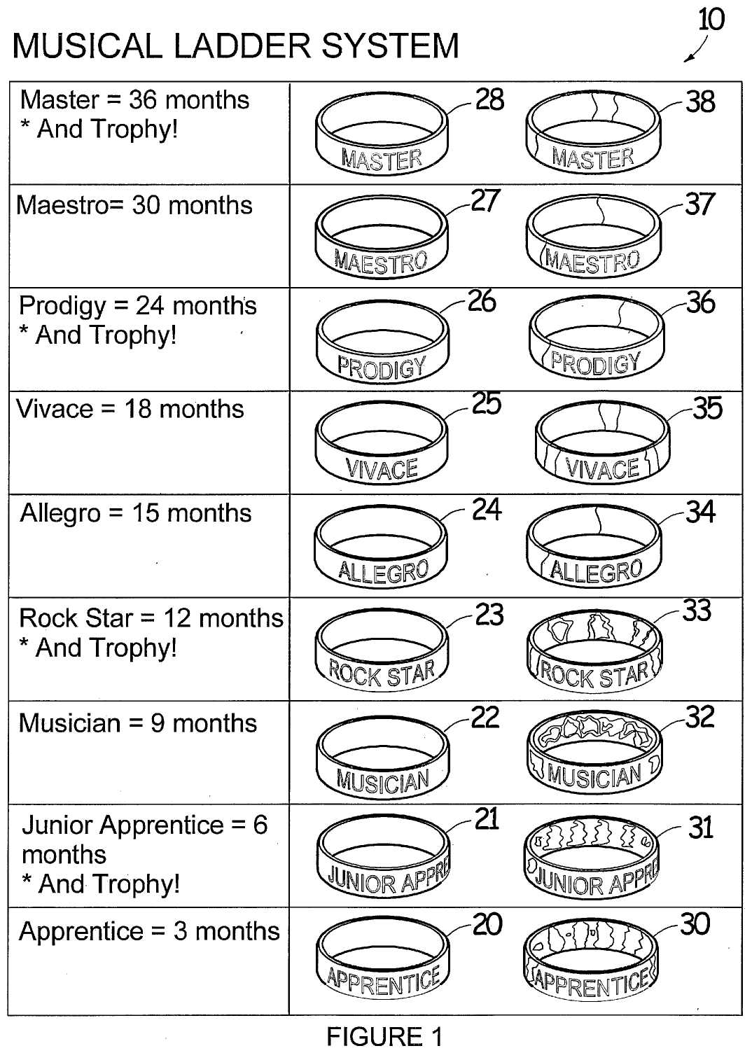

A method of music instruction according to a preferred embodiment of the invention is illustrated in FIG. 1 and shown generally at reference numeral 10. The method is referred to herein as a “MUSICAL LADDER SYSTEM.” In accordance with the MUSICAL LADDER SYSTEM 10, students are awarded physical decorations, such as various distinctively colored and/or labeled wristbands 20 upon completion of various levels of musical training. Each wristband 20 awarded provides a sense of accomplishment to the student and provides an incentive for the student to continue his/her music lessons.

A student receives a distinct decorative wristband upon completing various intervals of training. Each wristband for completing each particular level of training can have a distinctive color and/or words printed thereon.

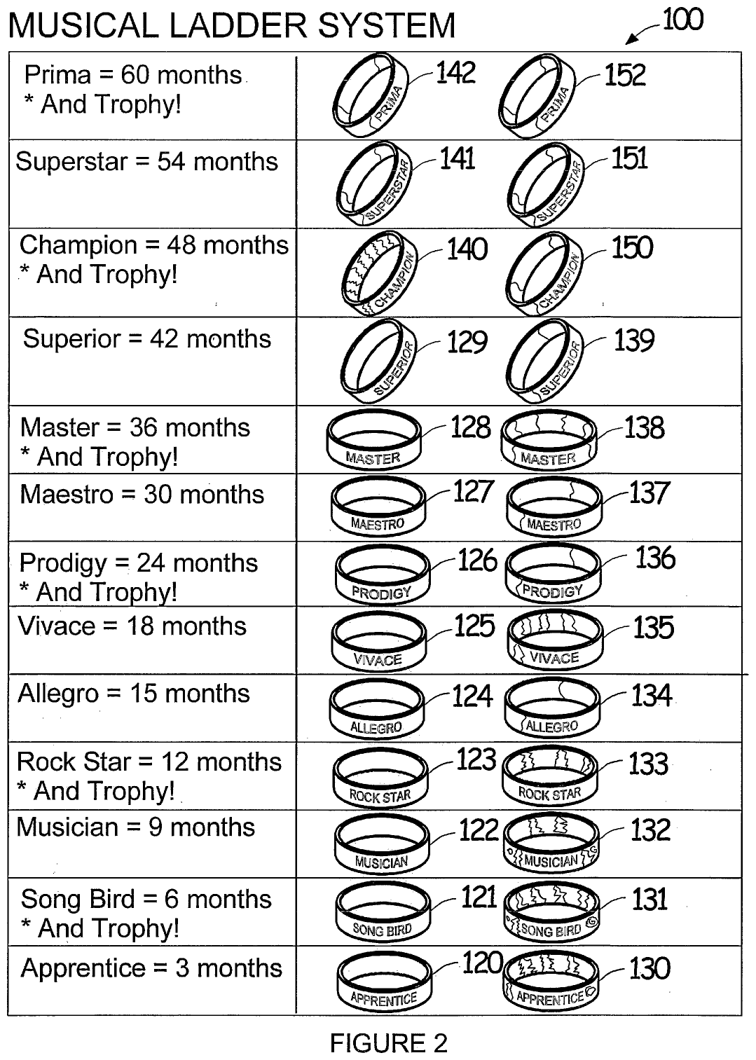

As shown in FIG. 1, a student receives the first wristband 20, 30 upon completing the first three months of lessons. The wristband awarded to the student for completing three months of instrumental music lessons can have “APPRENTICE” written thereon, as shown at reference numeral 20 in FIG. 2. Alternatively, a student taking voice lessons can receive a wristband that has “SONG BIRD”. A different wristband is awarded after completing each three-month interval thereafter until reaching eighteen months.

As shown in FIG. 1, the student can receive a wristband 21, 31 labeled “JUNIOR APPRENTICE” upon completing six months of lessons. Upon completing nine months of lessons, the student can receive a wristband 22, 32 labeled “MUSICIAN.” Upon completing twelve months of lessons, the student can receive a wristband 23, 33 labeled “ROCK STAR.” The student can also receive a trophy at twelve months. Upon completing fifteen months of lessons, the student can receive a wristband 24, 34 labeled “ALLEGRO.” Upon completing eighteen months of lessons, the student can receive a wristband 25, 35 labeled “VIVACE.”

After eighteen months, a different wristband is awarded at each six month interval until reaching “MASTER” status at thirty-six months. As shown in FIG. 1, the student can receive a wristband 26, 36 labeled “PRODIGY” upon completing twenty-four months of lessons. Upon completing thirty months of lessons, the student can receive a wristband 27, 37 labeled “MAESTRO.” Upon completing thirty-six months of lessons the student receives the “MASTER” wristband 28, 38. The student can also receive a trophy at this point.

The wristbands can be made of silicone rubber or other suitable materials. The assigned names, such as APPRENTICE, MUSICIAN, etc., can be debossed, embossed, printed, or laser-engraved onto the wristband, or affixed thereon by other suitable means. Preferably, the wristbands are made of silicone and the assigned names are debossed with white ink. Alternatively, the wristbands can be made of a metal such as gold, silver, nickel or platinum, or other suitable material.

Each wristband can be a single distinct color, as represented by the wristbands shown at reference numerals 20-28 in FIG. 1 or can be multi-colored as represented by the wristbands shown at reference numerals 30-38 in FIG. 1. Preferably, different colors are used, and each unicolored wristband 20-28 is a different color. Upon completing each level of training, the student is given the choice of a unicolored wristband 20-28 or the corresponding multi-colored wristband 30-38. For example, upon completing the first three months of music lessons the student is given the choice of either the solid-colored wristband 20 or the corresponding multi-colored wristband 30. Alternatively, the student can receive both the single-colored wristband 20 and the corresponding multi-colored wristband 30 upon completion of each particular interval of training. Preferably, a substantial portion of each of the multi-colored wristbands 30-38 is the same color as its corresponding single colored wristband 20-28. For example, single-colored wristband 20 can be red, and its corresponding multi-colored wristband 30 can be substantially red with black sections or lines.

In an alternative embodiment, the wristbands can be awarded based on the amount of time of lessons that have been completed by the student in conjunction with specific tests that must be passed by the student at each specific interval of time. For example, upon completing three months of lessons the student is given his or her first musical test, which must be successfully passed by the student in order to get the three month “APPRENTICE” wristband shown as 20 and 30. Likewise, after completing six months of lessons, the student is given a second test, having a more advanced degree of difficulty than the previous test given at the three-month juncture. If the student successfully passes the second test, he or she is awarded the six month “SENIOR APPRENTICE” wristband.

The system 10 can include a parent portal software in which parents of students can log in and view their child's progress for: the next award coming up, teacher notes, important dates, and their child's ‘status’ on the MUSICAL LADDER.

It is critical that the first test and reward be provided when the student has completed three months of lessons. Applicant has found that a majority of music students become frustrated and give up on learning their instrument within the first two months of lessons. As such, a goal and reward provided at the three-month mark, gives an incentive to students to persevere through the critical second month, thereby dramatically increasing the rate of retention. At the first training session, the student's first test should be scheduled with the instructor for three months after the first session.

This test can be reinforced by the parent portal that parents and students can access to anticipate and prepare for the first three-month test. Then students prepare for tests every three months or six months thereafter.

Applicant has determined that the above time benchmarks (three months, six months, nine months, twelve months, fifteen months, eighteen months, twenty-four months, thirty months, and thirty-six months) are critical to maximizing music student retention.

Student retention can be vital for a music school, as it results in students taking more lessons over a longer period of time thereby increasing revenue. Increased retention rates also increase the number of referrals of new students. The MUSICAL LADDER SYSTEM 10 can provide a competitive marketing advantage as parents seek out schools that reward students in this unique way.

The MUSICAL LADDER SYSTEM 10 can be a significant market game changer for the music lesson industry as children are often unable to communicate with their parents due to their maturity as to “how” they are progressing in their musical training. The MUSICAL LADDER SYSTEM 10 solves this problem via its strategically timed award achievement calendar and online parent notification system.

FIG. 2 illustrates a method of musical instruction according to another preferred embodiment of the invention. A student receives the first wristband 120, 130 upon completing the first three months of lessons, and the wristband awarded to the student for completing three months of instrumental music lessons can have “APPRENTICE” written thereon, as shown in FIG. 2. The student can receive a wristband 121, 131 labeled “SONG BIRD” upon completing six months of lessons. Upon completing nine months of lessons, the student can receive a wristband 122, 132 labeled “MUSICIAN.” Upon completing twelve months of lessons, the student can receive a wristband 123, 133 labeled “ROCK STAR.” The student can also receive a trophy at twelve months. Upon completing fifteen months of lessons, the student can receive a wristband 124, 134 labeled “ALLEGRO.” Upon completing eighteen months of lessons, the student can receive a wristband 125, 135 labeled “VIVACE.”

After eighteen months, a different wristband is awarded at each six-month interval until reaching “PRIMA” status at sixty months. As shown in FIG. 2, the student can receive a wristband 126, 136 labeled “PRODIGY” and a trophy upon completing twenty-four months of lessons. Upon completing thirty months of lessons, the student can receive a wristband 127, 137 labeled “MAESTRO.” Upon completing thirty-six months of lessons the student receives a wristband 128, 138 labeled “MASTER” and a trophy. Upon completing forty-two months of lessons, the student can receive a wristband 129, 139 labeled “SUPERIOR.” Upon completing forty-eight months, the student can receive a wristband 140, 150 labeled “CHAMPION” and a trophy. Upon completing fifty-four months of lessons the student can receive a wristband 141, 151 labeled “SUPERSTAR.” Upon completing sixty months of lessons, the student can receive a wristband 142, 152 labeled “PRIMA” and a trophy.

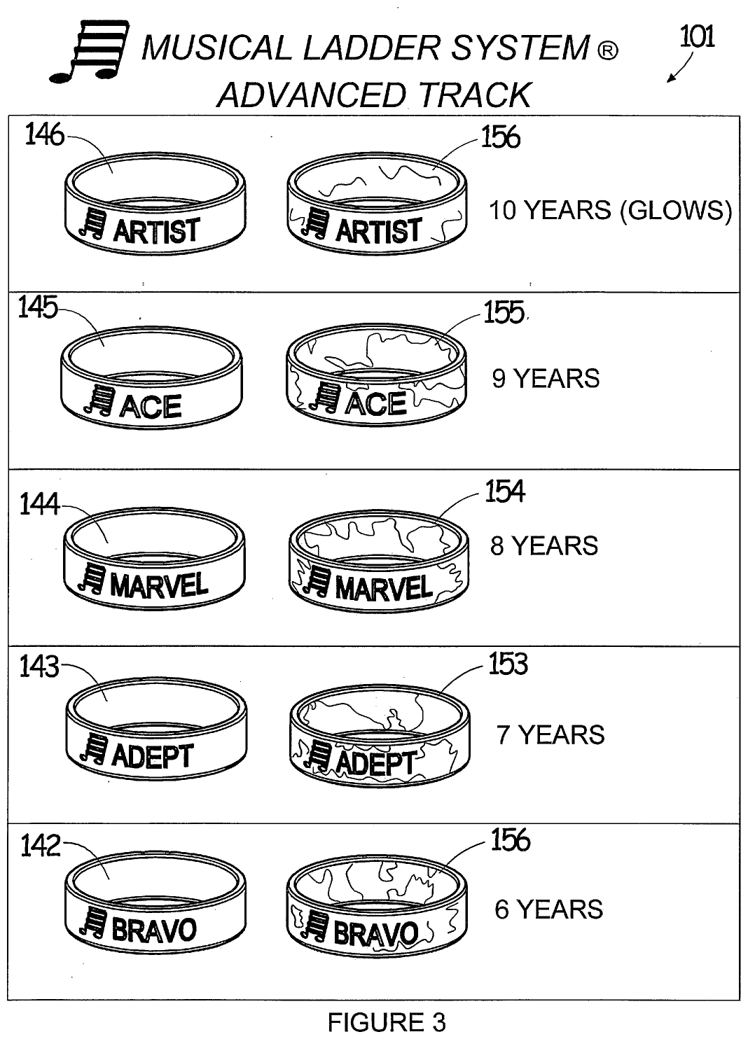

According to another embodiment of the invention, shown generally at reference numeral 101 in FIG. 3, the wristband awards can continue beyond five years. As shown in FIG. 3, wristband awards can be awarded on an annual basis from years six to ten. Upon completion of six years of lessons the student can receive a wristband 142, 152 labeled “BRAVO”. Upon completion of seven years of lessons, the student can receive a wristband 143, 153 labeled “ADEPT.” Upon completion of eight years of lessons, the student can receive a wristband 144, 154 labeled “MARVEL.” Upon completion of nine years of lessons the student can be awarded a wristband 145, 155 labeled “ACE.” Upon completion of ten years of lessons, the student can be awarded a wristband 146, 156 labeled “ARTIST.”

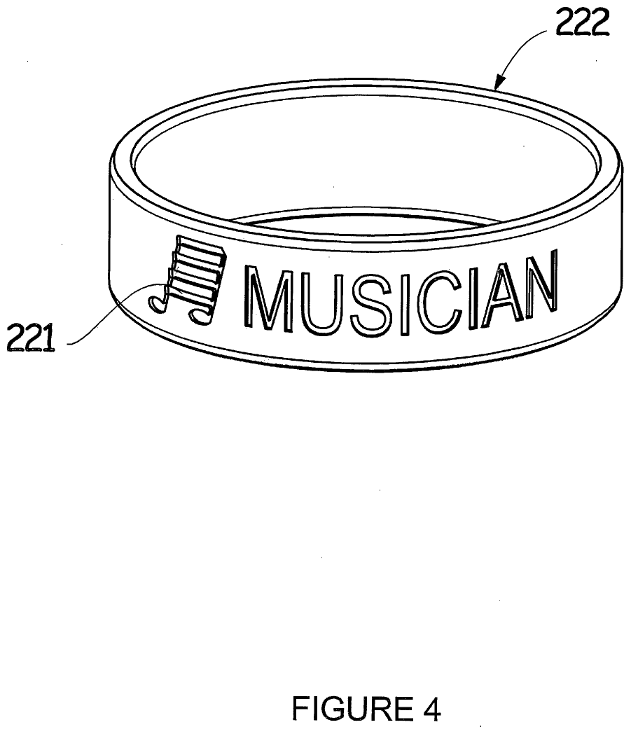

In an alternative embodiment of the invention, each wristband can include a decorative logo as shown at reference numeral 221 on wristband 222 in FIG. 4.

It should be noted that while preferred embodiments of the invention are described above as using wristbands, the invention is not so limited. Alternatively, other accessories, such as scarves, necklaces, bracelets, and rings can be used in place of the wristbands.

Another preferred embodiment of the invention comprises a method of operating a business, such as a music school. A music school owner can collect and maintain data regarding how many months each student has been a student with the school, and using this data generates “student retention” reports. The music school owner can collect and maintain data regarding which media source (e.g., Internet website, print media advertisement, radio advertisement, television advertisement, and personal referral) initially brought each student to the music school. Cross referencing this data with student retention information for each student, “media spend” reports can be generated showing how many months each student has been with the school based upon the media source that brought them to the school. The “media spend” report can provide data regarding which media sources are most effective at attracting students who remain at the school the longest, and which media sources tend to attract students with high attrition rates. As such, the “media spend” reports can provide guidance to the music school owner as to which media sources to invest resources in. For example, the media spend report may reveal that students who initially discover the music school by the school's Internet website stay with the school on average six months longer than students.

The music school owner can collect and maintain data regarding how many months each student has been with each teacher. Using this data, “teacher retention” reports can be generated which show teachers at the school are performing at the highest level with the least student attrition.

The music school owner can collect and maintain data regarding which instrument each student is playing and cross reference that data with data regarding how many months each student has been with the school to generate “instrument retention” reports. As such, the “instrument retention” reports can show which instruments are more likely to have students with higher retention, and which instruments are likely to lead to earlier attrition. The music school owner can collect and maintain data regarding how many months all students have been with the school to generate “school wide retention” reports.

Another embodiment of the invention comprises a non-transitory computer readable storage medium adapted for maximizing efficiency of a music school. The non-transitory computer readable storage medium can be comprised of software comprising programming instructions that, when executed, causes a computer processor to access and analyze various data regarding the music school and generate a variety of reports relating to the music school. The reports provide guidance to the music school owner that can help maximize profitability of the music school.

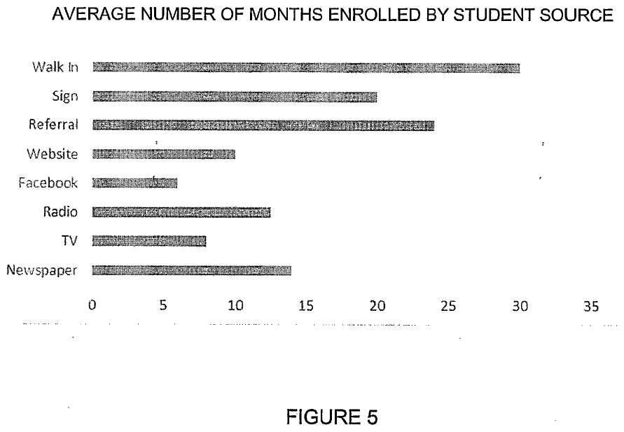

The software program includes programming for receiving data regarding how many months each student has been a student with the music school and storing this data in a student retention database. Using this data, the software causes a computer processor to generate “student retention” reports. The software program includes programming for receiving data regarding the means by which each student initially came to the music school (e.g., Internet website, social media, print media advertisement, radio advertisement, television advertisement, personal referral, walk-in), and storing this data in a student source database. The software cross references this data with student retention information for each student and generates “student source” reports showing how many months each student has been with the school based upon the media source that brought them to the school. The “student source” report can include a graph as shown in FIG. 5. The “student source” report can provide data regarding which media sources are most effective at attracting students who remain at the school the longest, and which media sources tend to attract students with high attrition rates.

The software can receive data regarding how many months each student has been with each teacher and store this information in a teacher retention database. Using this data, the software can generate “teacher retention” reports showing which teachers at the school are performing at the highest level with the least student attrition. The software can receive data regarding which instrument each student is playing and store this data in an instrument retention database. The software can cross reference the information in the instrument retention database with the information in the student retention database and generate “instrument retention” reports.

The software can receive and maintain data regarding each student such as, the child's current status/level on any one of the MUSICAL LADDER systems 10, 100 described above, and other dates such as the student's next upcoming award, teacher notes/comments, and important dates/deadlines. The software can provide for a “parent portal”, in which parents of students can log in via the Internet and view their child's progress toward the next upcoming award, teacher notes/comments, important dates/deadlines, and their child's ‘status’ on any one of the MUSICAL LADDER systems 10, 100 described above.

The software can include a “teacher portal”, in which each teacher can log in, review his or her roster of students, set dates for tests, send notes to parents, send email notifications to parents, and list recital dates. The software can include an “administrators' portal” by which school administrators can log in, review the roster of students, set the dates tests, send notes to parents, send email notifications to parents, list recital dates, edit teacher test dates, etc.

In another embodiment, the invention comprises a non-transitory computer readable storage medium adapted for implementing the music ladder system and retaining students. The non-transitory computer readable storage medium can be comprised of software comprising programming instructions that, when executed, causes a computer processor to access and analyze various data regarding the music students and generate a variety of reports relating to the music school.

The software program includes programming for receiving data such as a student progress data, and/or an instrument retention data. The student progress data can represent a current progress level of a student's musical training representing and can include information such as the length of time that the student has been taking lessons, the total amount of lesson time the student has taken, and/or the number of lessons the student has taken. In each case these time periods can be calculated on an instrument-by-instrument basis or an aggregate basis where the time is calculated regardless of which instrument, or the number of instruments involved in the lesson. The instrument retention data can represent an amount of time that the musical student takes music lessons with a particular instrument and can include, on an instrument-by-instrument basis, as the length of time that the student has been taking lessons, the total amount of lesson time the student has taken, and/or the number of lessons the student has taken. This information may be stored on a database that is in communication with the software or stored on computer readable medium that is included in a server or a computer that is in communication with the software.

Once the software has retrieved the student retention data, it may determine or otherwise identify a predetermined time threshold associated with and/or corresponding to the student progress data and/or the instrument retention data and represents the length of time the student has been taking lessons, the total lesson time taken by the student and/or the number of lessons taken by the student. The predetermined time threshold can be associated with the above identified times as calculated on an aggregate basis or on an instrument-by-instrument basis.

The software can then compare the student progress data and/or the instrument retention data to determine whether the student has met the predetermined threshold associated with the student's progress level identified by the student progress data and/or the instrument retention data.

Upon determining whether the predetermined time threshold has been met, the software can display, on a computer display that is in communication with the software, a notification indicating and/or representing whether the student progress data and/or the instrument retention data exceeds the predetermined time threshold. If the predetermined time threshold has been met, the software can further determine, identify and/or display an award level that corresponds to or is associated with the predetermined time threshold. In at least one embodiment, the awards and time thresholds used for the Music Ladder discussed above may be used for determining which award level should be identified and/or provided to the student. display an identification of an award level corresponding to the notification. In the event that a student's retention data and/or instrument retention data exceeds more than one predetermined time threshold (such as for a student who is transferring into the music school and/or the music ladder system, the software may determine each award to which the student is entitled by determining each predetermined time threshold that has been exceeded by the student retention data and/or instrument retention data associated with the student progress data for the student. That way, the software may determine if a second, third, etc. award level has been met according, at least in part, to the student progress data record so that the student may receive more than one award and/or may receive the highest award level to which the student is entitled.

In alternate embodiments the software can determine whether both the predetermined time threshold has been met and whether the student has passed a progress level test. In such an embodiment, the software first determines whether the predetermined time threshold has been met as described above. Next the software determines, identifies and/or displays, on a computer display that is in communication with the software, a progress level test that corresponds to and/or is associated with the student progress data and/or the predetermined time threshold associated with the student progress data. The software can also determine, identify and/or display the time threshold associated with the progress level test, wherein the time threshold represents a minimum required (a) length of time the student has been taking lessons, (b) total lesson time taken by the student and/or (c) number of lessons taken by the student. The time threshold can be calculated on an aggregate basis or on an instrument-by-instrument basis.

Once the time threshold is determined, the software can compare the student retention data and/or instrument data to determine whether the student meets the minimum time threshold associated with the progress level test to be taken. If so, the software can create and/or display a notification that the student meets the time threshold and therefore qualifies to take the progress level test.

Once the progress test is administered and the student progress data is updated, the software can determine whether the student passed the progress level test. If software determines and/or identifies that the student has both met the time threshold and passed the corresponding progress level test, the software may identify an award to be presented to the student.

In any or each of the above described embodiments, the software may transmit, using a global computer network, a progress data to a parent portal, wherein the progress data represents one of a set of teacher notes, a child's progress towards a next award level in the set of award levels and a comparison of the award level achieved by the student to the next award level not yet achieved by the student. The software may do this in the manners described herein as well as those generally known in the art.

A method of music instruction and a method operating a music school are described above. Various changes can be made to the invention without departing from its scope. The above description of various embodiments of the invention are provided for the purpose of illustration only and not limitation the invention being defined by the claims and equivalents thereof.

What is claimed is:

1. A computerized method for motivation and retention of a musical student comprising:
a computer having a computer readable medium; and, a set of computer readable instructions included on the computer configured to:
receive a student progress data record representing a current progress level of musical training of the musical student;
receive an instrument retention data representing an amount of time that the musical student takes music lessons with an instrument;
identify a predetermined time threshold associated with the student progress data, wherein the predetermined time threshold is selected from the student's total lesson time the length of time that the student has been taking lessons and the length of time that the student has been taking lessons with an instrument;
display a notification representing whether the instrument retention data exceeds the predetermined time threshold associated with the student progress data;
display an identification of an award level corresponding to the notification; and,
transmit using a global computer network a progress data to a parent portal, wherein the progress data represents one of a set of teacher notes, a child's progress towards a next award level in the set of award levels and a comparison of the award level achieved by the student to the next award level not yet achieved by the student.

2. The computerized method of claim 1 wherein the award associated with the award level is a wristband.

3. The computerize method of claim 1 wherein the award level is a first award level, and the set of server computer readable instructions include instructions configured to determine if a second award level has been met according, at least in part, to the student progress data record.

4. The computerize method of claim 3 wherein the award level is a first award level associated with a first award and wherein the set of server computer readable instructions include instructions configured to indicate that a second award should be given to the musical student according, at least in part, to whether a second award level has been met.

5. The computerized method of claim 4 wherein the second award is a wristband.

6. The computerize method of claim 1 wherein the set of server computer readable instructions include instructions configured to generate a student retention report having a student retention rate associated with the musical student.

7. The computerized method of claim 1 wherein the computer readable instructions are further configured to determine a progress level test according, at least in part, to the student progress data record; and wherein the notification displayed further represents whether the student has passed the progress level test.

8. The computerize method of claim 1 wherein the set of server computer readable instructions are further configured to generate a student retention report for each award level in the set of award levels where in each award level is associated with a period of time that the musical student takes music lessons.

9. The computerized method of claim 1 wherein each award level in the set of award levels represents a three-month interval relative to a preceding award level.

10. A computerize method for motivation and management of musical students comprising:
a server having a server computer readable medium;
a set of server computer readable instructions include on the server configured to:
receive a student progress data record representing a current progress level of musical training of the musical student;
determine a progress level test according, at least in part, to the student progress data record;
determine a time threshold associated with the progress level test, wherein the time threshold represents a minimum required amount of time that the student has been taking musical training;
compare the student progress data to the time threshold to determine whether the time threshold has been met;
upon determining that the time threshold has been met, determine whether the student has passed the progress level test; and,
identify an award to be presented to the student according, at least in part, to a determination that the time threshold has been met and a determination that the progress level test has been passed.

11. The computerized method of claim 10 wherein the award is a first award that is taken from a set of awards wherein each award in the set of awards is associated with a different length of time of taking musical training.

12. The computerized method of claim 11 wherein the set of awards are wristbands.

13. The computerized method of claim 10 including a teacher data record associated with the student record representing a teacher of the student and the set of non-transitory computer readable instructions are configured to generate a student retention report having a student retention rate associated with the teacher.

14. The computerized method of claim 10 wherein the set of non-transitory computer readable instructions are configured to determine an instrument retention data representing an amount of time that the student has music training for an instrument and generate an instrument retention report having an instrument retention rate associated with the instrument.

15. The computerized method of claim 10 wherein the set of non-transitory computer readable instructions are further configured to identify the award according, at least in part, a determination that an instrument retention data exceeds the time threshold.

16. A computerized method for motivation and retention of musical students comprising:
a computer readable medium;
a student record stored on the computer readable medium representing a student; and,
a set of non-transitory computer readable instructions in communications with the computer readable medium configured to:
receive a student progress data record stored on the computer readable medium and associated with the student record representing a time that the student has received musical training;
determine a time threshold according, at least in part, to the student progress data, wherein the time threshold is selected from the student's total lesson time, the length of time that the student has been taking lessons, and the length of time that the student has been taking lessons for an instrument;
determine whether the student retention data exceeds the time threshold,
upon determining that the student retention data exceeds the time threshold, determine an award level associated with the time threshold.

17. The computerized method of claim 16 wherein the set of non-transitory computer readable instructions are further configured to generate a retention report according, at least in part, to the student retention data.

18. The computerized method of claim 16 wherein the computer readable instructions are further configured to determine a progress level test according, at least in part, to the student progress data record; and wherein the award level is determined according to, at least in part, a determination as to whether the student has passed the progress level test.

19. The computerized method of claim 16 wherein the computer readable instructions are further configured to transmit using a global computer network a progress data to a parent portal, wherein the progress data represents one of a set of teacher notes, a child's progress towards a next award level in the set of award levels and a comparison of the award level achieved by the student to the next award level not yet achieved by the student.
